(19) United States
(12) Patent Application Publication
(10) Pub. No.: US 2018/0103229 A1
(43) Pub. Date: Apr. 12, 2018

(54) DISPLAY APPARATUS, ELECTRONIC APPARATUS CONNECTABLE TO DISPLAY APPARATUS, AND METHOD FOR CONTROLLING THE SAME

(71) Applicant: SAMSUNG ELECTRONICS CO., LTD., Suwon-si (KR)

(72) Inventors: Geun-sam YANG, Suwon-si (KR); Dae-woo CHO, Yongin-si (KR)

(21) Appl. No.: 15/716,815

(22) Filed: Sep. 27, 2017

(30) Foreign Application Priority Data
Oct. 6, 2016 (KR) 10-2016-0128893

(51) Int. Cl. H04N 5/44; H04N 5/232; H04W 76/02

(52) U.S. Cl. CPC H04N 5/4403; H04N 2005/4432; H04W 76/02; H04N 5/232

(57) ABSTRACT

A display apparatus is provided. The display apparatus includes a display configured to display an image, a speaker configured to output sound corresponding to identification information identifying the display apparatus, a communicator comprising communication circuitry configured to wirelessly receive response information corresponding to the identification information from an external apparatus that received the sound, and a processor configured to perform pairing with the external apparatus that transmitted the response information and to control the display to display an image corresponding to a control command received from the paired external apparatus.

### CROSS-REFERENCE TO RELATED APPLICATION

This application is based on and claims the priority under 35 U.S.C. § 119 to Korean Patent Application No. 10-2016-0128893, filed on Oct. 6, 2016, in the Korean Intellectual Property Office, the disclosure of which is incorporated by reference herein in its entirety.

### BACKGROUND

### 1. Field

The present disclosure relates generally to a display apparatus, an electronic apparatus connectable to a display apparatus, and a method for controlling the same, and for example, to a display apparatus which performs pairing easily using sound, an electronic apparatus connectable to a display apparatus, and a method for controlling the same.

### 2. Description of Related Art

With the recent development of electronic technologies, various types of Radio Frequency (RF) communication methods have been used for communication of electronic apparatuses.

The RF communication methods may include Bluetooth, Zigbee, binary Code Division Multiple Access (CDMA), high-frequency/low-frequency RF communication method, or the like.

For connecting the RF communication, pairing between apparatuses is required. Accordingly, users are given an instruction manual for a pairing process and carry out operations for the pairing between the apparatuses by referring to the instruction manual in general.

However, some users without background knowledge on the pairing may feel confused with the process or fail to set up the pairing in some cases.

### SUMMARY

The present disclosure has been provided to address the aforementioned and other problems and disadvantages occurring in the related art, and an example aspect of the present disclosure provides a display apparatus which performs pairing easily using sound, an electronic apparatus connectable to a display apparatus, and a method for controlling the same.

According to an example embodiment of the present disclosure, a display apparatus is provided. The display apparatus includes a display configured to display an image, a speaker configured to output sound corresponding to identification information identifying the display apparatus, a communicator comprising communication circuitry configured to wirelessly receive response information corresponding to the identification information from an external apparatus that received the sound, and a processor configured to perform pairing with the external apparatus that transmitted the response information and to control the display to display an image corresponding to a control command received from the paired external apparatus.

In response to trigger information being received from the external apparatus through the communicator, the processor may control the speaker to output the sound corresponding to the identification information.

In response to an advertising packet including the trigger information being received through the communicator, the processor may control the speaker to output the sound corresponding to the identification information.

In response to trigger information being received from another external apparatus through the communicator while the display apparatus is paired with the external apparatus, the processor may disable the pairing with the external apparatus and control the speaker to output the sound corresponding to the identification information.

In response to trigger information being received from another external apparatus through the communicator while the display apparatus is paired with the external apparatus, the processor may control the speaker to output the sound corresponding to the identification information, and in response to the response information corresponding to the identification information being received though the communicator after the sound is output, disable the pairing between the display apparatus and the external apparatus and perform pairing with the another external apparatus.

The communicator may communicate with the external apparatus through a Bluetooth method.

The response information may be an advertising packet including the identification information.

The processor may include a main processor configured to control the speaker and a sub processor configured to control the communicator, and the main processor may do not operate in a sleep state of the display apparatus. In response to trigger information being received from the external apparatus through the communicator in the sleep state of the display apparatus, the sub processor may wake up the main processor.

The processor and the communicator may communicate through a Universal Serial Bus (USB) method.

According to an example embodiment of the present disclosure, an electronic apparatus connectable to a display apparatus is provided. The electronic apparatus includes a microphone configured to receive sound, a processor configured to, in response to the sound received through the microphone including identification information, generate response information corresponding to the identification information, and a communicator comprising communication circuitry configured to perform pairing with the display apparatus by transmitting the generated response information.

The electronic apparatus may further include a plurality of buttons. In response to manipulation of at least one button among the plurality of buttons being detected while there is no paired external apparatus, the processor may control the communicator to transmit trigger information for outputting sound corresponding to the identification information through a peripheral device.

The processor may incorporate the trigger information in an advertising packet and transmit the trigger information through the communicator.

The processor may activate the microphone after the trigger information is transmitted.

In response to the electronic apparatus being paired with the display apparatus after the trigger information is transmitted, the processor may control the communicator to transmit a control command corresponding to the manipulated button.

In response to manipulation of at least one button among the plurality of buttons being detected while the electronic apparatus is paired with the display apparatus, the processor may control the communicator to transmit the control command corresponding to the manipulated button to the display apparatus.

The communicator may communicate with the display apparatus through a Bluetooth method.

The response information may be an advertising packet including the identification information.

According to an example embodiment of the present disclosure, a method for controlling an electronic apparatus connectable to a display apparatus is provided. The method includes receiving sound through a microphone, generating, in response to the received sound including identification information, response information corresponding to the identification information, and performing pairing with the display apparatus by transmitting the generated response information.

The method may further include transmitting, in response to manipulation of at least one button among a plurality of buttons of the electronic apparatus being detected while there is no external apparatus paired with the electronic apparatus, trigger information for outputting sound corresponding to the identification information through a peripheral device.

The transmitting the trigger information may include incorporating and transmitting the trigger information in an advertising packet.

### BRIEF DESCRIPTION OF THE DRAWINGS

The above and/or other aspects, features and attendant advantages of the present disclosure will be more apparent and readily appreciated from the following detailed description, taken in conjunction with the accompanying drawings, in which like reference numerals refer to like elements, and wherein:

FIG. 1 is a block diagram illustrating an example structure of a display apparatus according to an example embodiment of the present disclosure;

FIG. 2 is a block diagram illustrating an example structure of an electronic apparatus connectable to a display apparatus according to an example embodiment of the present disclosure;

FIG. 3 is a diagram illustrating an example system including a display apparatus and an electronic apparatus according to an example embodiment of the present disclosure;

FIG. 4 is a sequence diagram illustrating an example pairing process between a display apparatus and an electronic apparatus according to an example embodiment of the present disclosure;

FIGS. 5A, 5B, 6A and 6B are diagrams illustrating example pairing methods between a display apparatus and an electronic apparatus according to various example embodiments of the present disclosure;

FIG. 7 is a flowchart illustrating an example method for controlling a display apparatus according to an example embodiment of the present disclosure; and

FIG. 8 is a flowchart illustrating an example method for controlling an electronic apparatus connectable to a display apparatus according to an example embodiment of the present disclosure.

### DETAILED DESCRIPTION

In the following description, well-known functions or constructions may not be described in detail as they may obscure the application with unnecessary details. The terms used in the following description are expressions defined by considering functions in the present disclosure and may vary depending upon intentions or relations of a user or an operator. Accordingly, the terms should be defined based on overall descriptions of the present disclosure.

A term with an ordinal, for example, ‘first’ or ‘second,’ may be used to distinguish elements, but the elements are not limited by the ordinal. The ordinal is used to only distinguish the same or similar elements.

The terms used in the following description are provided to describe specific example embodiments and are not intended to limit the scope of the present disclosure. A term in a singular form includes a plural form unless it is intentionally written that way. In the following description, a term, such as, ‘include’ or ‘consist of’, refers to the disclosed features, numbers, steps, operations, elements, parts, or combinations thereof and is not intended to exclude any possibilities of existence or addition of one or more other features, numbers, steps, operations, elements, parts, or combinations thereof.

In the various example embodiments disclosed herein, a term ‘module’ or ‘unit’ may refer, for example, to an element that performs one or more functions or operations. The ‘module’ or ‘unit’ may be realized as hardware, software, or any combinations thereof. A plurality of ‘modules’ or ‘units’ may be integrated into at least one module and realized as at least one processor, except for a case where the respective ‘modules’ or ‘units’ need to be realized as discrete specific hardware.

Hereinafter, various example embodiments will be described in greater detail to be easily embodied by a person having ordinary skill in the art (hereinafter referred to as ‘those skilled in the art’) with reference to the accompanying drawings. The present disclosure may be realized as various different forms and is not limited to the example embodiments disclosed and described herein. In the accompanying drawings, a part unrelated to the description may be omitted for a more clear description, and like drawing reference numerals are used for the like elements, even in different drawings, throughout the entire disclosure.

Certain embodiments are described in greater detail below with reference to the accompanying drawings.

The following description relates generally to a pairing method between two electronic apparatuses.

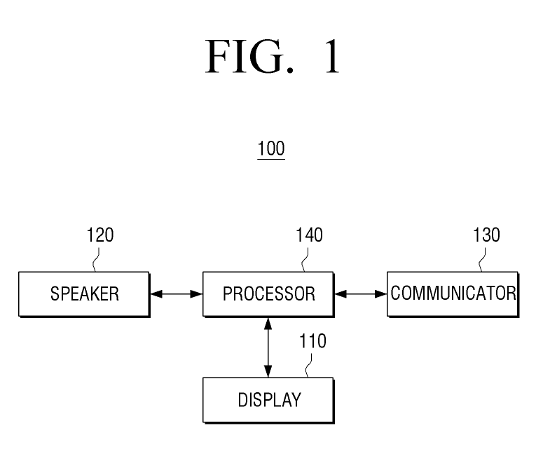

FIG. 1 is a block diagram illustrating an example structure of a display apparatus, the display apparatus being one of the electronic apparatuses to be paired.

Referring to FIG. 1, a display apparatus 100 includes a display 110, a speaker 120, a communicator (e.g., including communication circuitry) 130, and a processor (e.g., including processing circuitry) 140. The display apparatus 100 may be realized as an electronic apparatus, such as, for example, and without limitation, a television (TV), a Personal Computer (PC), a smart phone, or Personal Digital Assistant (PDA), or the like.

The display 110 displays an image. For example, the display 110 may be realized as Liquid Crystal Display (LCD) or realized as Cathode-Ray Tube (CRT), Plasma Display Panel (PDP), Organic Light-Emitting Diode (OLED), transparent OLED, or the like, but is not limited thereto. Further, the display 110 may be realized as a touch screen for detecting user's touch manipulation.

The speaker 120 outputs sound. The speaker 120 may output sound with a particular frequency band according to control of the processor 140.

The sound output through the speaker 120 may be sound of an audible frequency band or sound of a non-audible frequency band. The sound of the audible frequency band may have a sound frequency ranging from 20 Hz to 20 KHz that humans can hear. The sound of the non-audible frequency band may have a sound frequency ranging from 10 kHz to 300 GHz that humans cannot hear.

The communicator 130 may include various communication circuitry and performs communication with diverse external apparatuses. The communicator 130 may access to an external apparatus through a Local Area Network (LAN) and an internet network. Further, the communicator 130 may access to an external apparatus through wireless communication (for example, and without limitation, Z-wave, 4Lo Wireless Personal Area Network (WPAN), Radio Frequency Identification (RFID), Long Term Evolution Disk-to-Disk (LTE D2D), General Packet Radio Service (GPRS), Weightless, Edge Zigbee, ANT+, Near Field Communication (NFC, Infrared Data Association (IrDA), Digital European Cordless Telephone (DECT), Wireless Local Area Network (WLAN), Bluetooth, Wireless-Fidelity (Wi-Fi), Wi-Fi Direct, Global System for Mobile Communication (GSM), Universal Mobile Telephone System (UMTS), Long Term Evolution (LTE), Wireless Broadband Internet (WiBRO), or the like). The communicator 130 may include various communication chips including various communication circuitry, such as, for example, and without limitation, a Wi-Fi chip, a Bluetooth chip, or a wireless communication chip, or the like.

The processor 140 may include various processing circuitry, such as, for example, and without limitation, a dedicated processor, a CPU, or the like, and controls overall operations of the display apparatus 100. The processor 140 may include a Central Processing Unit (CPU), a Random Access Memory (RAM), a Read-Only Memory (ROM), and a system bus. In the above description, the processor 140 includes one CPU, but in the implementation, the processor 140 may include, for example, and without limitation, a plurality of CPUs (or Digital Signal Processors (DSPs) or Microprocessor Units (MPUs)), or the like.

The processor 140 may control the speaker 120 to output sound corresponding to identification information for identifying the display apparatus 100. In this case, the sound corresponding to the identification information may be the sound of the non-audible frequency band.

The identification information may be unique information of the display apparatus 100. By way of example, and without limitation, the identification information may be a device name, a serial number, or the like, of the display apparatus 100. Further, the identification information may be information generated by the processor 140 arbitrarily. The processor 140 may generate new identification information for each case where the sound corresponding to the identification information needs to be outputted through the speaker 120. The identification information comprising numbers may be called Personal Identification Number (PIN).

In response to a predetermined event occurring while there is no apparatus paired with the display apparatus 100, the processor 140 may control the speaker 120 to output the sound corresponding to the identification information. As an example, in response to an event where Alternating Current (AC) power is applied to the display apparatus 100 that was reset to factory settings or an event where a preset cycle arrives while there is no paired apparatus, the processor 140 may control the speaker 120 to output the sound corresponding to the identification information.

As another example, in response to an event where trigger information is received from an external apparatus through the communicator 130, the processor 140 may control the speaker 120 to output the sound corresponding to the identification information.

In this case, the trigger information may be incorporated in an advertising packet and received through the communicator 130. The advertising packet may be used to transmit signals to all apparatuses around the display apparatus 100 without designating a particular apparatus. The advertising packet may be a undirected type and may be a Bluetooth packet (for example, one of a Bluetooth classic packet and a Bluetooth Low Energy (BLE) packet).

For example, the communicator 130 may scan the advertising packet including the trigger information at preset intervals through a Bluetooth method. In response to the advertising packet including the trigger information being received through the communicator 130, the processor 140 may control the speaker 120 to output the sound corresponding to the identification information.

According to an embodiment, the display apparatus 100 may operate in a sleep state or in a normal state. The normal state refers to a state where an image is displayed through the display 110, and the sleep state refers to a state where a power plug of the display apparatus 100 is connected to an electrical outlet, and the display apparatus 100 is powered off. The processor 140 may include, for example, and without limitation, a main processor that operates in the normal state and does not operate in the sleep state and a sub processor that operates in the sleep state. The main processor may control the speaker 120 and the display 110, the sub processor may control the communicator 130.

In response to the trigger information being received from an external apparatus through the communicator 130 in the sleep state, the sub processor may wake up the main processor so that the sleep state is changed to the normal state. The main processor may control the speaker 120 to output the sound corresponding to the identification information.

The processor 140 and the communicator 130 may, for example, and without limitation, communicate through a USB method. As described above, in response to the trigger information being received in the sleep state, the communicator 130 may wake up the processor 140.

In response to the sound corresponding to the identification information being output through the speaker 120 and response information corresponding to the identification information being received from the external apparatus that received the sound through the communicator 130, the processor 140 may perform pairing with the external apparatus. For example, the external apparatus that received the sound corresponding to the identification information may enter a pairing mode after transmitting the response information corresponding to the identification information, and the display apparatus 100 may enter a pairing mode in response to receiving the response information corresponding to the identification information. Accordingly, the external apparatus and the display apparatus 100 may be paired.

Sound has properties making it difficult for sound to go through a wall. Accordingly, receiving the response information corresponding to the identification information from a certain external apparatus after the display apparatus outputs the sound corresponding to the identification information signifies that the external apparatus may be located in the same place as the display apparatus 100. In other words, the sound corresponding to the identification information may be used to determine whether an external apparatus to be paired exists in the same place. Further, the sound may be used as an indicator for enabling the external apparatus to enter the pairing mode.

In this case, the response information may be an advertising packet including the identification information. The advertising packet may be used to transmit signals to all apparatuses around the display apparatus 100 without designating a particular apparatus. The advertising packet may be a undirected type and a Bluetooth packet (for example, one of a Bluetooth classic packet and Bluetooth Low Energy (BLE) packet).

In response to receiving a control command from the paired external apparatus through the communicator 130, the processor 140 may perform an operation corresponding to the received control command. By way of example, the processor 140 may control the display 110 to display an image corresponding to the received control command, control a volume of the display apparatus 100 according to the received control command, or turn on or turn off the display apparatus 100.

In response to the trigger information being received from another external apparatus through the communicator 130 while the external apparatus is paired with the display apparatus 100 through the above process, the processor 140 may disable the pairing with the current external apparatus and then control the speaker 120 to output the sound corresponding to the identification information.

For example, the received trigger information may include apparatus information on an apparatus that transmitted the trigger information. Accordingly, in response to the trigger information being received through the communicator 130 while the display apparatus 100 is paired with a certain apparatus (a first apparatus) and determining that the trigger information was transmitted from another apparatus (a second apparatus) different from the currently paired external apparatus, the processor 140 may disable the pairing with the first apparatus and then control the speaker 120 to output the sound corresponding to the identification information. In response to the sound being output and then the response information corresponding to the identification information being received from the second apparatus that received the sound through the communicator 130, the processor 140 may enter the pairing mode and perform pairing with the second apparatus.

In the above embodiment, the pairing is disabled when the trigger information is received from the second apparatus that is different from the currently paired first apparatus. However, according to another example embodiment, the processor 140 may disable the pairing with the first apparatus and perform pairing with the second apparatus when the trigger information is received from the second apparatus through the communicator 130, the processor 140 controls the speaker 120 to output the sound corresponding to the identification information, and the response information corresponding to the identification information is received from the second apparatus that received the sound through the communicator 130. That is, according to this example embodiment, the processor 140 may disable the pairing with the first apparatus only when confirming that the second apparatus is located in the same place as the display apparatus 100.

According to the above-described embodiments, in the Bluetooth communication allowing only one-to-one connection of the apparatuses, the processor 140 may disable the pairing with the currently paired apparatus automatically without user manipulation for disabling the paring and perform pairing with another apparatus.

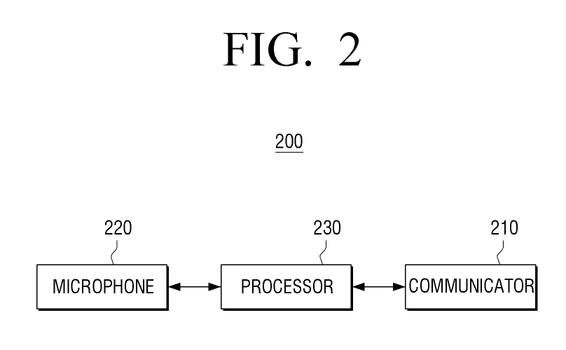

FIG. 2 is a block diagram illustrating an example structure of an electronic apparatus connectable to the display apparatus 100 according to an example embodiment of the present disclosure.

Referring to FIG. 2, an electronic apparatus 200 includes a communicator (e.g., including communication circuitry) 210, a microphone 220, and a processor (e.g., including processing circuitry) 230. The electronic apparatus 200 may be realized as an electronic apparatus, such as, for example, and without limitation, a smart phone or a remote controller, or the like.

The communicator 210 may include various communication circuitry and performs communication with diverse external apparatuses. The communicator 210 may access to an external apparatus through a Local Area Network (LAN) and an internet network. Further, the communicator 210 may access to an external apparatus through wireless communication (for example, and without limitation, Z-wave, 4Lo Wireless Personal Area Network (WPAN), Radio Frequency Identification (RFID), Long Term Evolution Disk-to-Disk (LTE D2D), General Packet Radio Service (GPRS), Weightless, Edge Zigbee, ANT+, Near Field Communication (NFC, Infrared Data Association (IrDA), Digital European Cordless Telephone (DECT), Wireless Local Area Network (WLAN), Bluetooth, Wireless-Fidelity (Wi-Fi), Wi-Fi Direct, Global System for Mobile Communication (GSM), Universal Mobile Telephone System (UMTS), Long Term Evolution (LTE), Wireless Broadband Internet (WiBRO), or the like). The communicator 210 may include various communication circuitry and chips, such as, for example, and without limitation, a Wi-Fi chip, a Bluetooth chip, or a wireless communication chip, or the like.

The microphone 220 receives sound. The sound received through the microphone 220 may be the sound of the audible frequency band or the sound of the sound of the non-audible frequency band. The sound of the audible frequency band may have a sound frequency ranging from 20 Hz to 20 KHz that humans can hear. The sound of the non-audible frequency band may have a sound frequency ranging from 10 kHz to 300 GHz that humans cannot hear.

The processor 230 may include various processing circuitry, such as, for example, and without limitation, a dedicated processor, a CPU, or the like, and controls overall operations of the electronic apparatus 200. The processor 230 may include a Central Processing Unit (CPU), a Random Access Memory (RAM), a Read-Only Memory (ROM), and a system bus. In the above description, the processor 230 includes one CPU, but in the implementation, the processor 230 may include, for example, and without limitation, a plurality of CPUs (or Digital Signal Processors (DSPs) or Microprocessor Units (MPUs)), or the like.

In response to the sound received through the microphone 220 including the identification information, the processor 230 may generate the response information corresponding to the identification information.

For example, the processor 230 may analyze the received sound and determine whether the sound includes predefined identification information. In response to determining that the sound includes predefined identification information, the processor 230 may generate the response information. That is, the processor 230 does not generate the response information in response to general sound without the predefined identification information (for example, voices or ambient noises).

In this case, the response information may be an advertising packet including the identification information. The advertising packet may be used to transmit signals to all apparatuses around the display apparatus 100 without designating a particular apparatus. The advertising packet may be a undirected type and may be a Bluetooth packet (for example, one of a Bluetooth classic packet and a Bluetooth Low Energy (BLE) packet).

The processor 230 may control the communicator 210 to transmit trigger information for enabling a peripheral device to output the sound corresponding to the identification information. For example, the electronic apparatus 200 may include a plurality of buttons. In response to manipulation to at least one button among the plurality of buttons being detected while there is no apparatus paired with the electronic apparatus 200 or in response to a user's gesture of gripping the electronic apparatus 200 being detected, the processor 230 may control the communicator 210 to transmit the trigger information.

In this case, the processor 230 may incorporate the trigger information in the advertising packet and transmit the trigger information through the communicator 210. The advertising packet may be used to transmit signals to all apparatuses around the display apparatus 100 without designating a particular apparatus. The advertising packet may be a undirected type and may be a Bluetooth packet (for example, one of a Bluetooth classic packet and a Bluetooth Low Energy (BLE) packet).

Among the plurality of buttons of the electronic apparatus 200, a button that triggers off transmission of the trigger information may be provided specially for a pairing operation. As an example, the electronic apparatus 200 may be a remote controller providing a button for pairing separately from other general buttons, and an external apparatus to be paired with the electronic apparatus 200 may be a TV. In this case, the trigger information may be transmitted in response to the pairing button being pressed. In response to the remote controller being paired with the TV, a user may press a general button of the remote controller, for example, a power-on button, in order to turn on the TV. That is, according to this example embodiment, when the user wishes to turn on the TV, the user should press the pairing button of the remote controller and then press the power-on button.

According to still another example embodiment, any of the plurality of buttons of the electronic apparatus 200 may be used as the button for triggering off the transmission of the trigger information. As an example, the electronic apparatus 200 may be a remote controller, and an external apparatus to be paired with the electronic apparatus 200 may be a TV. In this case, the user pressing the power-on button of the remote controller in order to turn on the TV, the trigger information may be transmitted. In response to the remote controller being paired with the TV by this operation, the processor 230 may transmit a control command corresponding to the power-on button, that is, a control command to turn on the TV to the TV directly. That is, according to this example embodiment, differently from the above embodiment, the user may turn on the TV by pressing the power-on button of the remote controller and does not need to perform additional operation for the pairing between the remote controller and the TV.

The processor 230 may keep the microphone 220 activated all the time so as to receive the sound corresponding to the identification information. Further, the processor 230 may keep the microphone 220 inactivated at other times and activate the microphone 220 after transmitting the trigger information as described above. In this case, the processor 230 may activate the microphone 220 only for a predetermined time after transmitting the trigger information.

In response to manipulation of at least one button among the plurality of buttons of the electronic apparatus 200 being detected while the electronic apparatus 200 is paired with the external apparatus, the processor 230 may control the communicator 210 to transmit a control command corresponding to the manipulated button to the external apparatus. As an example, when the external apparatus is the TV, and the electronic apparatus 200 is the remote controller, the control command may be a control command to control a volume, a control command to change a channel, or the like.

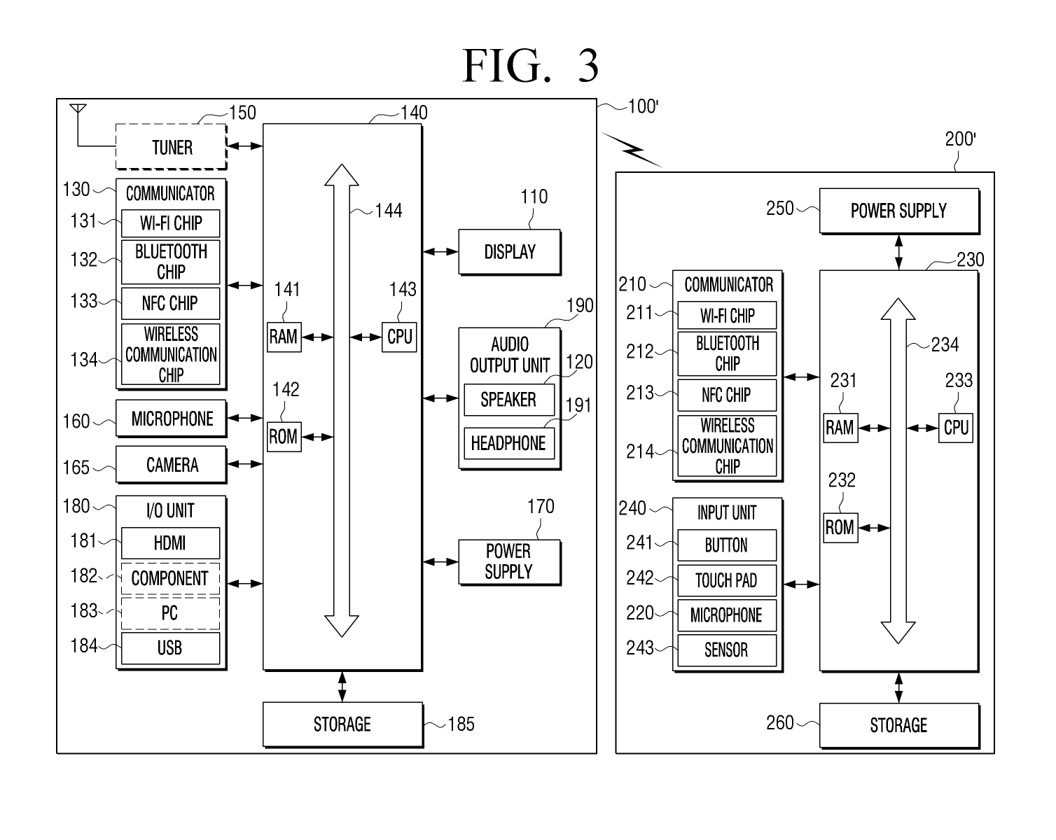

FIG. 3 is a diagram illustrating example structures when the display apparatus 100 is realized as a TV, and the electronic apparatus 200 is realized as a remote controller. In FIG. 3, a repeated description of elements discussed above may be omitted.

Referring to FIG. 3, a display apparatus 100′ may receive control information from an electronic apparatus 200′.

The display apparatus 100′ may be realized as, for example, and without limitation, an analog TV, a digital TV, a three-dimensional (3D)-TV, a smart TV, an LED TV, an OLED TV, a plasma TV, a monitor, a curved TV with a constant curvature-screen, a flexible TV with a constant curvature-screen, a bended TV a constant curvature-screen, and/or a curvature-variable TV where curvature of a current screen is changed by a user's input, or the like.

The display apparatus 100′ includes a tuner 150, a communicator (e.g., including communication circuitry) 130, a processor (e.g., including processing circuitry) 140, a microphone 160, a camera 165, an input/output (I/O) unit (e.g., including input/output circuitry) 180, a display 110, an audio output unit (e.g., including audio output circuitry) 190, a storage 185, and a power supply 170. Further, the display apparatus 100′ may include a sensor for sensing an internal state or an external state of the display apparatus 100′ (for example, an illumination sensor or a temperature sensor (not shown)).

The processor 140 may include various processing circuitry and controls overall operations of the display apparatus 100′ and a signal flow of internal components of the display apparatus 100′ and processes data. The processor 140 may control power supplied from the power supply unit 170 to the internal components.

The processor 140 may include a RAM 141, a ROM 142, a CPU 143, and a bus 144. The RAM 141, ROM 142, and CPU 143 may be interconnected through the bus 144. The processor 140 may be realized as a System on Chip (SoC).

The CPU 143 may access the storage 185 and perform a booting operation by using an Operating System (O/S) in the storage 185. Subsequently, the CPU 143 may perform various operations using programs, contents, or data in the storage 185.

The ROM 142 may store a command set for system booting. In response to the power being supplied by a turn-on command, the CPU 143 may copy the O/S in the storage 185 to the RAM 141 according to the commands stored in the ROM 142 and boot up a system by executing the O/S. Upon completion of the booting operation, the CPU 143 may copy various application programs in the storage 185 to the RAM 141 and execute the programs copied to the RAM 141 to perform various operations.

The processor 140 may include a main processor and a sub processor (not shown). In the sleep state, the main processor does not operate, whereas the sub processor may operate. The communicator 130 may be controlled by the sub processor in the sleep state. Accordingly, in the sleep state, the sub processor may control the power supply unit 170 to keep supplying power to the communicator 130. Further, in response to a BLE advertising packet including the trigger information being received via Bluetooth by the Bluetooth chip 132 of the communicator 130 in the sleep state, the sub processor may analyze the packet, interpret a wake-up reason code, and wake up the main processor. Accordingly, the main processor may control the speaker 120 to output the sound corresponding to the identification information and perform the pairing with the electronic apparatus 200′.

The sub processor may control the communicator 130 to keep connection with the electronic apparatus 200′ in the sleep state.

The display apparatus 100′ may operate in a ready state. The ready state refers to a state for preparing the display apparatus available. In the ready state, the main processor may operate and control the power supply unit 170 to supply power to the components except for the display 110. In the ready state, a pre-work for enabling the display 110 to display diverse contents may be performed.

The tuner 150 may include various circuitry to perform a processing operation, such as, amplification, mixing, or resonance, with respect to a broadcast signal received in a wired and/or wireless manner and tune and select only a frequency of a desired channel to be received in the display apparatus 100′ from among several radio wave components. The broadcast signal may include video, audio, and additional data (for example, Electronic Program Guide (EPG)).

The tuner 150 may receive the video, audio, and data from a frequency band corresponding to a channel number consistent with a user's input (for example, Channel 506 of cable broadcasting).

The tuner 150 may receive the broadcast signal from various sources, such as, terrestrial broadcasting, cable broadcasting, or satellite broadcasting. Further, the tuner 150 may receive the broadcast signal from analog broadcasting or digital broadcasting.

The tuner 150 may be realized as a single body with the display apparatus 100′ (all-in-one) or realized as a separate device with a tuner unit which is electrically connected to the display apparatus 100′ (for example, a set-top box or a tuner connected to the I/O unit 180).

The communicator 130 may include various communication circuitry and communicates with various types of external apparatuses according to diverse communication methods. The communicator 130 may include various communications circuitry and chips including, for example, and without limitation, a Wi-Fi chip 131, a Bluetooth chip 132, a NFC chip 133, a wireless communication chip 134, or the like. The Wi-Fi chip 131, the Bluetooth chip 132, and the NFC chip 133 may perform communication according to a Wi-Fi method, a Bluetooth method, and an NFC method, respectively. The wireless communication chip 134 may refer, for example, to a chip that performs communication according to various communication standards including, for example, and without limitation, Institute of Electrical and Electronics Engineers (IEEE), Zigbee, 3rd Generation (3G), 3rd Generation Partnership Project (3GPP), Long Term Evolution (LTE), or the like.

The Bluetooth chip 132 may refer, for example, to a chip including circuitry that operates according to a Bluetooth communication method using an Industrial Scientific Medical (ISM) band with 2.45 GHz. The ISM band may be used freely without license. In the Bluetooth communication using the Bluetooth chip 132, various connection information, such as, Subsystem Identification (SSID) and a session key, may be transmitted/received first for communication connection with the electronic apparatus 200′. In response to the electronic apparatus 200′ being connected, control information for controlling the display apparatus 100′ may be received from the electronic apparatus 200′, or various information may be transmitted to the electronic apparatus 200′.

The Bluetooth chip 132 may support Bluetooth Classic before Bluetooth 4.0 and Bluetooth Low Energy (BLE) after Bluetooth 4.0.

The display apparatus 100′ may receive an advertising packet based on Bluetooth Low Energy (BLE) standards from the electronic apparatus 200′. For example, the display apparatus 100′ may receive the advertising packet including the trigger information and the advertising packet including the identification information.

The storage 185 may store a Bluetooth profile.

The microphone 160 may receive sound. The microphone 160 may convert the received sound to an electric signal and output the signal to the processor 140. For example, a user's voice may be received through the microphone 160, and the processor 140 may perform an operation corresponding to the received user's voice.

The microphone 160 may be realized as a single body with the display apparatus 100′ (all-in-one) or realized as a separate device from the display apparatus 100′. The separate microphone 160 may be connected to the display apparatus 100′ electrically through the communicator 130 or the I/O unit 180.

The camera 165 may take a video, and the video may be used to recognize a user's motion. The sub processor may control the power supply unit 170 to supply power to the camera 165 in the sleep state. Accordingly, the user's motion may be recognized in the sleep state.

The camera 165 may be realized as a single body with the display apparatus 100′ (all-on-one) or realized as a separate device from the display apparatus 100′. The separate camera 165 may be connected to the display apparatus 100′ electrically through the communicator 130 or the I/O unit 180.

The I/O unit 180 may include various input/output circuitry for connecting the display apparatus 100′ with an external apparatus.

The I/O unit 180 may include various input/output circuitry, such as, for example, and without limitation, at least one of a High-Definition Multimedia Interface (HDMI) input port 181, a component input jack 182, a PC input port 183, and a USB input jack 184, or the like.

The audio output unit 190 may include various circuitry that outputs audio. For example, the audio output unit 190 may output audio included in the broadcast signal received through the tuner 150, audio input through the communicator 130 or the I/O unit 180, or audio included in an audio file stored in the storage 185.

The audio output unit 190 may include various audio output circuitry, such as, for example, and without limitation, the speaker 120 and a headphone output terminal 191. The speaker 120 may output the sound corresponding to the identification information under the control of the processor 140. In this case, the processor 140 may control the speaker 120 to output the sound corresponding to the identification information with the non-audible frequency band.

The storage 185 may store diverse data, programs, or applications for driving and controlling the display apparatus 100′ according to the control of the processor 140. The storage 185 may store input/output signals or data corresponding to the operations of the tuner 150, the communicator 130, the microphone 160, the camera 165, the I/O unit 180, the display 110, the audio output unit 190, and the power supply 170.

The storage 185 may store the identification information and Bluetooth profile. The identification information may be a Personal Identification Number (PIN).

The storage 185 may be realized, for example, and without limitation, as a non-volatile memory, a volatile memory, a flash-memory, a Hard Disk Drive (HDD), or a Solid State Drive (SSD), or the like. Further, the storage 185 may be realized as an external storage medium, for example, a micro Secure Digital (SD) card, a USB memory, or a web server based on networks, as well as an internal storage medium of the display apparatus 100′, or the like.

The power supply 170 may supply power inputted from an external power source to the components in the display apparatus 100′ according to the control of the processor 140.

The power supply 170 may supply power to the sub processor that controls the communicator 130 in the sleep state and the communicator 130. For example, in the sleep state, the sub processor may control the communicator 130 to perform the communication only through the Bluetooth communication method.

Hereinafter, a more detailed description of a structure of the electronic apparatus 200′ will be provided.

Referring to FIG. 3, the electronic apparatus 200′ includes a communicator (e.g., including communication circuitry) 210, a processor (e.g., including processing circuitry) 230, an input unit (e.g., including input circuitry) 240, a storage 260, and a power supply 250. The electronic apparatus 200′ may be realized, for example, and without limitation, as a remote controller for remotely controlling the display apparatus 100′.

The processor 230 may include a RAM 231, a ROM 232, a CPU 233, and a bus 234. The RAM 231, the ROM 232, and the CPU 233 may be interconnected through the bus 234. The processor 230 may be realized as a System On Chip (SoC).

The communicator 210 may include various communication circuitry and communicates with various types of external apparatuses according to diverse communication methods. The communicator 210 may include various communication circuitry, such as, for example, and without limitation, at least one of a Wi-Fi chip 211, a Bluetooth chip 212, an NFC chip 213, and a wireless communication chip 214.

According to an example embodiment, the electronic apparatus 200′ may be realized so as to support only the Bluetooth communication method.

In the Bluetooth communication, various connection information, such as, Subsystem Identification (SSID) and a session key, may be transmitted/received first for communication connection with the display apparatus 100′. In response to the display apparatus 100′ being connected, control information for controlling the display apparatus 100′ may be transmitted to the display apparatus 100′, or various information may be received from the display apparatus 100′.

The Bluetooth chip 212 may support Bluetooth Classic before Bluetooth 4.0 and Bluetooth Low Energy (BLE) after Bluetooth 4.0.

The processor 230 may control the communicator 210 to broadcast an advertising packet based on the Bluetooth low energy standards. For example, the advertising packet including the trigger information and the advertising packet including the identification information may be broadcasted.

The input unit 240 may include various input circuitry, such as, for example, and without limitation, one or more buttons 241 or a touch pad 242, or the like, for receiving a user's input for controlling the display apparatus 100′ (for example, touch or press). The input unit 240 may include a microphone 220 for receiving a user's voice, one of the user's inputs, and a sensor 243 for detecting a user's motion. For example, the microphone 220 may receive the sound corresponding to the identification information.

The input unit 240 may output an electrical signal (for example, an analog signal or digital signal) corresponding to the received user's input (for example, a touch, a press, a touch gesture, a voice, or a motion) to the processor 230.

The sensor 243 may include various sensors including sensing circuitry, such as, for example, and without limitation, a geomagnetic sensor, an acceleration sensor, or a gyro sensor, or the like, for detecting the motion of the electronic apparatus 200′, for example. Further, the sensor 243 may include a force sensor or a pressure sensor for detecting a user's contact or a user's grip with respect to a surface of the electronic apparatus 200′. Further, the sensor 243 may include a grip sensor for detecting a user's grip with respect to the electronic apparatus 200′.

The storage 260 may store diverse data, programs, or applications for driving and controlling the electronic apparatus 200′ according to the control of the processor 230.

The storage 260 may include information on the electronic apparatus 200′. By way of example, the storage 260 may include a model number, unique device ID, a Bluetooth version, or Bluetooth profile of the electronic apparatus 200′.

The power supply 250 supplies power to the components of the electronic apparatus 200′ according to the control of the processor 230. The power supply 250 may supply power from one or two or more batteries mounted on the electronic apparatus 200′ to the components of the electronic apparatus 200′.

In response to any of an event where any of the one or more buttons 241 is pressed, an event where the sensor 243 detects the user′ grip with respect to the electronic apparatus 200′, and an event where a battery is mounted on the electronic apparatus 200′ while there is no apparatus paired with electronic apparatus 200′, the processor 230 may control the communicator 210 to transmit the trigger information. For example, the processor 230 may control the communicator 210 to broadcast a BLE advertising packet including the trigger information.

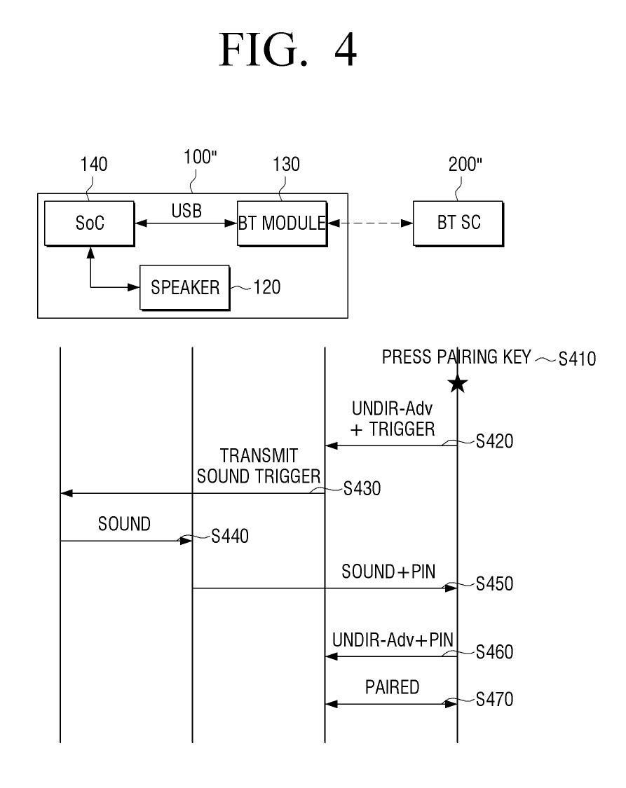

FIG. 4 is a sequence diagram illustrating an example pairing process between a first electronic apparatus 100″ and a second electronic apparatus 200″ according to an example embodiment of the present disclosure.

The first electronic apparatus 100″ and the second electronic apparatus 200″ may be Consumer Electronics (CE) with a Bluetooth module. The first electronic apparatus 100″ and the second electronic apparatus 200″ may be realized as any kind of electronic apparatuses providing the Bluetooth communication.

The second electronic apparatus 200″ may include a plurality of buttons, and a button for pairing is selected from among the plurality of buttons (S410). In response to the button for pairing being selected, the electronic apparatus 200″ may broadcast a undirected BLE advertising packet including the trigger information (S420). Meanwhile, the second electronic apparatus 200″ may do not have the button for pairing. In this case, in response to determining that there is no apparatus paired with the second electronic apparatus 200″, a undirected advertising packet (Undir-Adv) including the trigger information may be broadcasted in response to any button being pressed.

The first electronic apparatus 100″ may receive the advertising packet broadcasted from the second electronic apparatus 200″ by performing a BLE scanning operation.

According to an example embodiment, the BLE scanning operation of the Bluetooth module of the first electronic apparatus 100″ may be performed while the first electronic apparatus 100′ is powered on. Accordingly, in this case, the user needs to press a power-on button of the first electronic apparatus 100′. In case of the first electronic apparatus 100″ that has been factory reset, the first electronic apparatus 100″ may be powered on automatically by simply connecting the power plug to the electrical outlet, without pressing the power-on button.

According to still another embodiment, the BLE scanning operation of the Bluetooth module may be performed when the power plug is connected to the electrical outlet even though the first electronic apparatus 100″ is powered off. Accordingly, in this case, the first electronic apparatus 100″ may receive the advertising packet broadcasted from the second electronic apparatus 200″ without user's manipulation of pressing the power-on button.

In response to determining that the received advertising packet is a pairing trigger signal based on the trigger information in the advertising packet, the Bluetooth module may transmit sound trigger to the SoC (S430). In this case, in response to the SoC being in an inactivated state, the Bluetooth module may wake up the SoC.

The SoC may control the speaker to output the sound corresponding to the identification information (S440). The speaker outputs sound corresponding to the PIN (the identification information) (S450). The PIN may be pre-stored in the first electronic apparatus 100″ or may be newly generated every time sound is outputted.

The second electronic apparatus 200″ may include the microphone to receive the sound outputted from the first electronic apparatus 100″. After receiving the sound, the second electronic apparatus 200″ may broadcast a undirected BLE advertising packet including the PIN (S460). In this case, the second electronic apparatus 200″ may enter the pairing mode. In response to receiving the undirected BLE advertising packet including the PIN, the first electronic apparatus 200″ may enter the pairing mode. Subsequently, the pairing between the first electronic apparatus 100″ and the second electronic apparatus 200″ may be completed (S470).

The pairing process in the above embodiment may be performed in the conventional apparatus with the Bluetooth module of this embodiment. Accordingly, the Bluetooth module may be manufactured in the form of a USB dongle. As described in FIG. 4, the Bluetooth module and the SoC may be connected through the USB. Accordingly, the operation of transmitting the sound trigger (S430) may be performed through the USB communication.

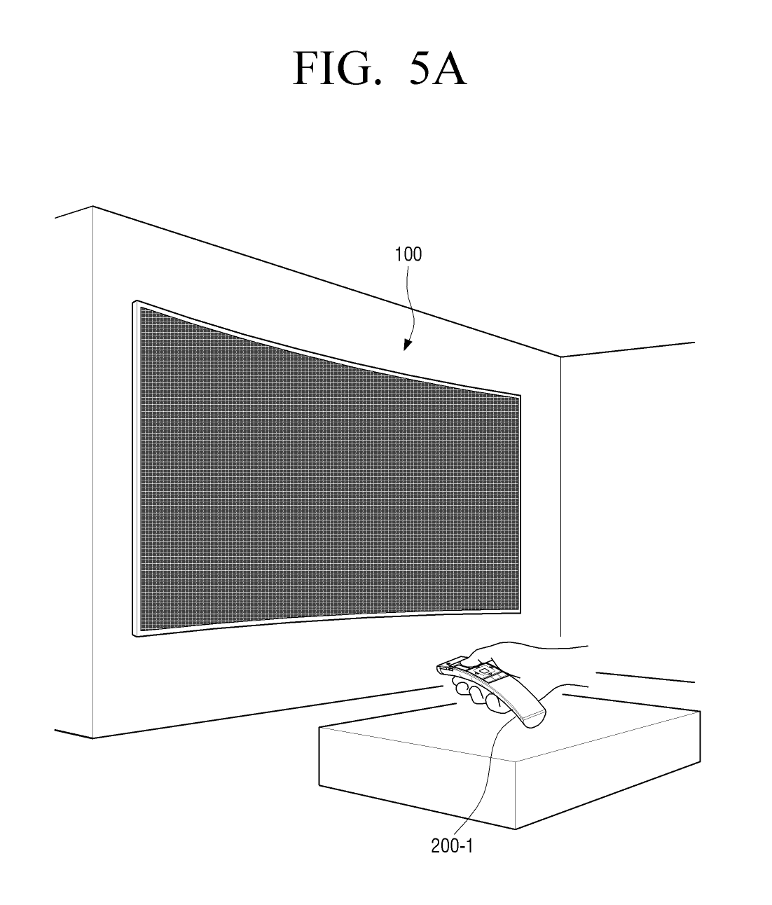

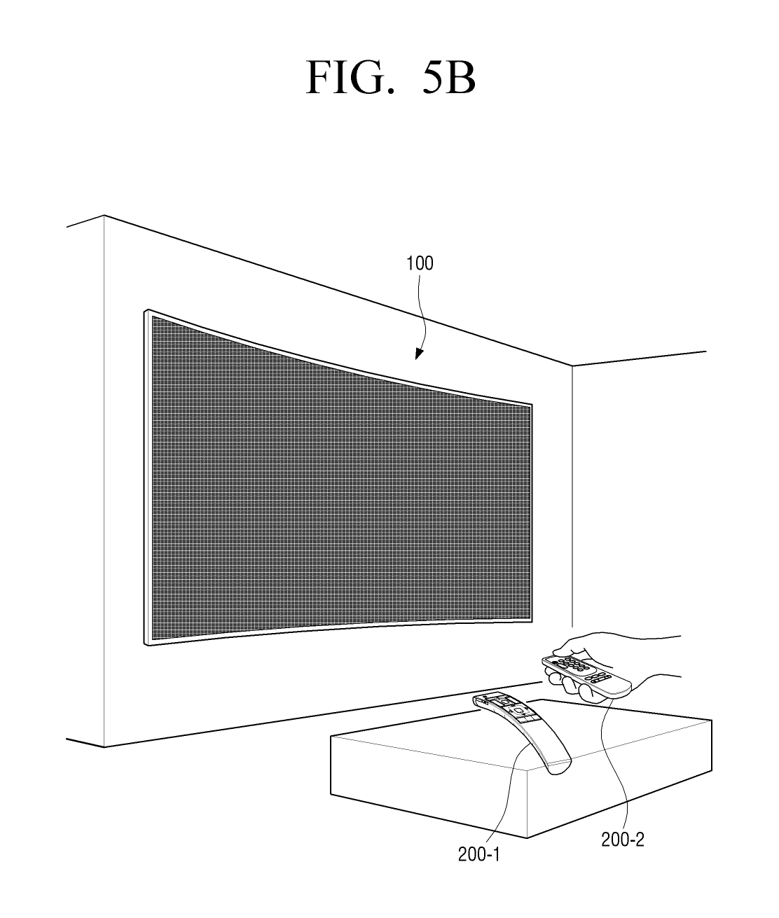

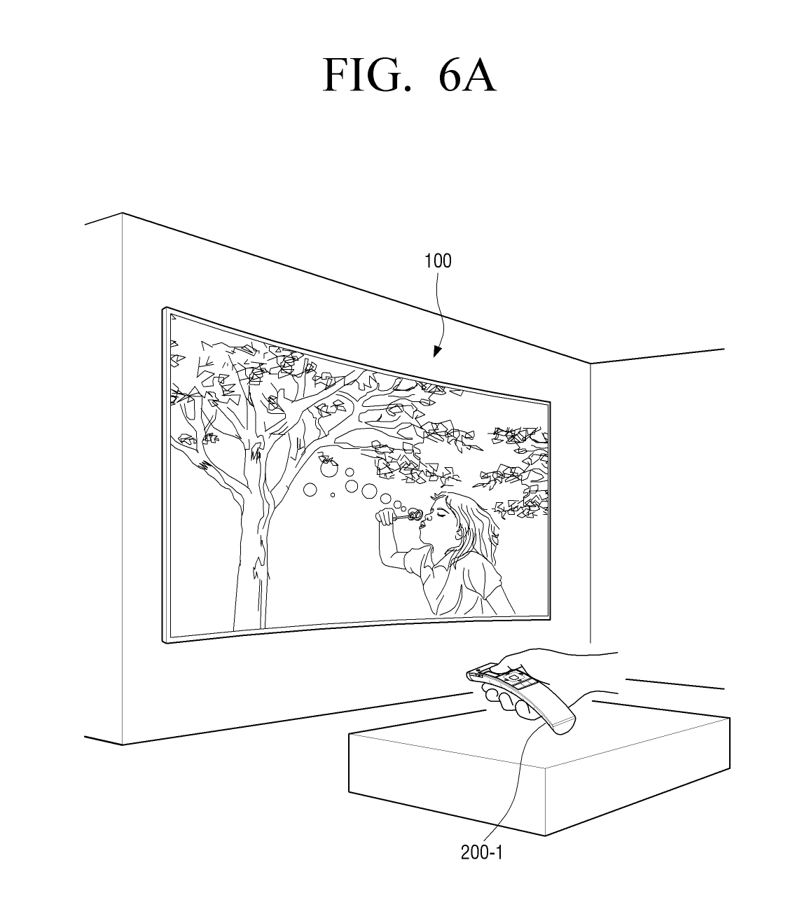

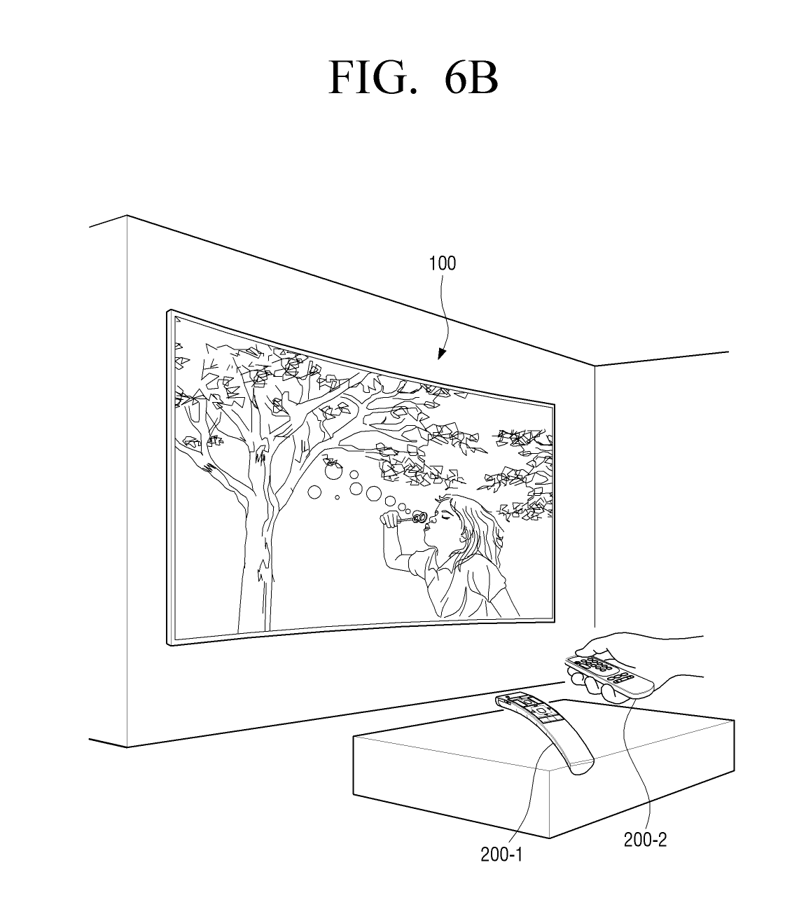

FIGS. 5A, 5B, 6A and 6B are diagrams illustrating an example communication process between the display apparatus 100 and a remote control apparatus 200-1, 200-2 according to various example embodiments of the present disclosure. The display apparatus 100 and the remote control apparatus 200-1, 200-2 may support the Bluetooth communication.

Referring to FIG. 5A, the display apparatus 100 is powered off and is not paired with the remote control apparatus 200-1. In this case, in response to the user pressing a power-on button of the remote control apparatus 200-1 to turn on the display apparatus 100, the following pairing operation between the display apparatus 100 and the remote control apparatus 200-1 may be performed in order to transmit a control command corresponding to the power-on button.

For example, the display apparatus 100 may perform the BLE scanning operation while being powered off. In response to manipulation to the power-on button, the remote control apparatus 200-1 may broadcast a BLE advertising packet including the trigger information. The display apparatus 100 may receive the broadcasted BLE advertising packet by the BLE scanning operation.

The display apparatus 100 may interpret and recognize the received BLE advertising packet as a pairing trigger signal. The display apparatus 100 may output the sound corresponding to the identification information through the speaker of the display apparatus 100.

The remote control apparatus 200-1 may receive the sound corresponding to the identification information through the microphone and enter the pairing mode while broadcasting the BLE advertising packet including the identification information. The display apparatus 100 may receive the BLE advertising packet including the identification information and enter the pairing mode. Accordingly, the pairing between the remote control apparatus 200-1 and the display apparatus 100 may be completed.

Upon completion of pairing, the remote control apparatus 200-1 may transmit the control information corresponding to the power-on button to the display apparatus 100, and the display apparatus 100 may be powered on according to the received control information.

In response to the display apparatus 100 being paired with the remote control apparatus 200-1, the display apparatus 100 may control the Bluetooth module so as to stand by in a connection mode while being powered off. Accordingly, in response to receiving a control command corresponding to the power-on button from the remote control apparatus 200-1 some time, the display apparatus 100 may be booted up quickly.

FIG. 5B is a diagram illustrating an example where a user who did not find (or use) the first remote control apparatus 200-1 tries to turn on the display apparatus 100 using the second remote control apparatus 200-2 while the display apparatus 100 and the first remote control apparatus 200-1 is paired.

Referring to FIG. 5B, in response to the user pressing a power-on button of the remote control apparatus 200-2 to turn on the display apparatus 100, the following pairing operation between the display apparatus 100 and the remote control apparatus 200-2 may be performed in order to transmit a control command corresponding to the power-on button.

For example, the display apparatus 100 may perform the BLE scanning operation while being powered off. In response to manipulation to the power-on button, the remote control apparatus 200-2 may broadcast the BLE advertising packet including the trigger information. The display apparatus 100 may receive the broadcasted BLE advertising packet by the BLE scanning operation.

In response to determining that the trigger information included the BLE advertising packet received from the remote control apparatus 200-2 does not correspond to the currently paired first remote control apparatus 200-1, the display apparatus 100 may disable the pairing with the first remote control apparatus 200-1 and output the sound corresponding to the identification information through the speaker of the display apparatus 100.

For example, the trigger information may be defined differently for each remote control apparatus. The display apparatus 100 may compare the trigger information included in the packet currently received from the second remote control apparatus 200-2 with the trigger information included in the packet previously received from the currently paired remote control apparatus 200-1. In response to determining that those trigger information are not the same, the display apparatus 100 may disable the pairing with the first remote control apparatus 200-1.

The remote control apparatus 200-2 may receive the sound corresponding to the identification information through the microphone and enter the pairing mode while broadcasting the BLE advertising packet including the identification information. The display apparatus 100 may receive the BLE advertising packet including the identification information and enter the pairing mode. Accordingly, the pairing between the remote control apparatus 200-2 and the display apparatus 100 may be completed.

Upon completion of pairing, the remote control apparatus 200-2 may transmit the control information corresponding to the power-on button to the display apparatus 100, and the display apparatus 100 may be powered on according to the received control information.

In the above example embodiments, the Bluetooth module of the display apparatus 100 is activated while the display apparatus 100 is powered off so as to receive the advertising packet all the time. However, according to another example embodiment, the Bluetooth module of the display apparatus 100 may be activated only when the display apparatus 100 is powered on for power saving. In this case, the display apparatus 100 should be powered on first so as to be paired with the remote control apparatus.

Accordingly, the user may turn on the display apparatus 100 first by using a physical button of the display apparatus 100. However, in many cases, a user without background knowledge on the pairing may try to turn on the display apparatus 100 by pressing the power-on button of the remote control apparatus 200-1. However, the display apparatus 100 is not powered on before the remote control apparatus 200-1 is paired with the display apparatus 100.

In order to address this problem, the display apparatus 100 that was factory-reset may be configured to be powered on automatically in response to the power plug being connected to the electrical output, as illustrated in FIG. 6A. In this case, the display apparatus 100 may display an initial screen or an instruction for enabling the user to perform the pairing. By way of example, the display apparatus 100 may display “Please press any button of the remote controller.”

In response to the user pressing a random button among the buttons of the remote control apparatus 200-1, for example, a power-off button, according to the instruction, the remote control apparatus 200-1 may broadcast the BLE advertising packet including the trigger information. The display apparatus 100 may receive the broadcasted advertising packet by the BLE scanning operation.

The display apparatus 100 may interpret and recognize the received the BLE advertising packet as the pairing trigger signal. The display apparatus 100 may output the sound corresponding to the identification information through the speaker of the display apparatus 100.

The remote control apparatus 200-1 may receive the sound corresponding to the identification information through the microphone and enter the pairing mode while broadcasting the BLE advertising packet including the identification information. The display apparatus 100 may receive the BLE advertising packet including the identification information and enter the pairing mode.

Accordingly, the pairing between the remote control apparatus 200-1 and the display apparatus 100 may be completed. Upon completion of pairing, the display apparatus 100 may display “Pairing with the remote controller completed. Now you can control a TV using the remote controller.” Meanwhile, such instruction does not necessarily need to be displayed. The remote control apparatus 200-1 may transmit the control command corresponding to the power-off button pressed by the user to the display apparatus 100, the display apparatus 100 may be powered off according to the control command.

FIG. 6B is a diagram illustrating an example where the display apparatus 100 is powered on and paired with the first remote control apparatus 200-1, and the user who did not find (or use) the first remote control apparatus 200-1 tries to control the display apparatus 100 using the second remote control apparatus 200-2.

Referring to FIG. 6B, in response to the user pressing the power-off button of the remote control apparatus 200-2, the following pairing operation between the display apparatus 100 and the remote control apparatus 200-2 may be performed in order to transmit a control command corresponding to the power-off button.

For example, in response to manipulation to the power-off button, the remote control apparatus 200-2 may broadcast the BLE advertising packet including the trigger information. The display apparatus 100 may receive the broadcasted advertising packet by the BLE scanning operation.

In response to determining that the trigger information included the BLE advertising packet received from the remote control apparatus 200-2 does not correspond to the currently paired first remote control apparatus 200-1, the display apparatus 100 may disable the pairing with the first remote control apparatus 200-1 and output the sound corresponding to the identification information through the speaker of the display apparatus 100.

The remote control apparatus 200-2 may receive the sound corresponding to the identification information through the microphone and enter the pairing mode while broadcasting the BLE advertising packet including the identification information. The display apparatus 100 may receive the BLE advertising packet including the identification information and enter the pairing mode. Accordingly, the pairing between the remote control apparatus 200-2 and the display apparatus 100 may be completed.

Upon completion of pairing, the remote control apparatus 200-2 may transmit the control information corresponding to the power-off button to the display apparatus 100, and the display apparatus 100 may be powered off according to the received control information.

According to the example embodiments of FIGS. 5A, 5B, 6A and 6B, the pairing between the display apparatus 100 and the remote control apparatus 200-1, 200-2 may be performed without requiring complicated manipulation by the user who may be unaware of details of the pairing procedure.

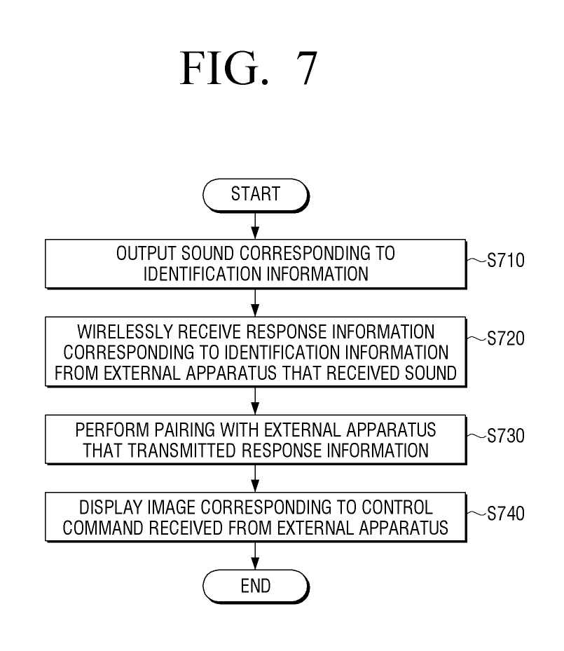

FIG. 7 is a flowchart illustrating an example method for controlling a display apparatus according to an example embodiment of the present disclosure.

Referring to FIG. 7, the display apparatus 100 may output the sound corresponding to the identification information for identifying the display apparatus (S710).

When there is sound of the audible frequency band that is currently being output from the display apparatus 100, the display apparatus 100 may output the sound corresponding to the identification information with the non-audible frequency band so as not to overlap the sound of the audible frequency band. When there is no sound of the audible frequency band that is currently being outputted from the display apparatus 100, the display apparatus 100 may output the sound corresponding to the identification information with the audible frequency band.

The display apparatus 100 may wirelessly receive the response information corresponding to the identification information from an external apparatus that received the sound corresponding to the identification information (S720). The wireless communication method applicable to this case may be the Bluetooth method, but not limited thereto. That is, the wireless communication in this case may be performed by any kind of wireless communication methods supported by the display apparatus 100 and the external apparatus.

The display apparatus 100 may perform pairing with the external apparatus that transmitted the response information (S730). Subsequently, the display apparatus 100 may display an image corresponding to a control command received from the paired external apparatus (S740), but not limited thereto. The display apparatus 100 may perform various operations depending to a received control command (for example, a volume-up operation in response to a control command to increase a volume).

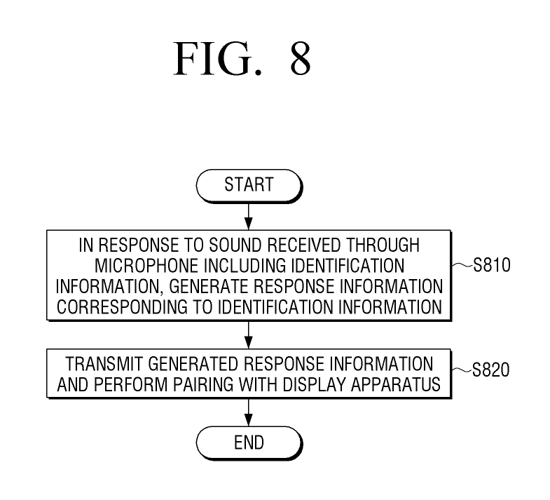

FIG. 8 is a flowchart illustrating an example method for controlling an electronic apparatus connectable to a display apparatus according to an example embodiment of the present disclosure.

Referring to FIG. 8, the electronic apparatus 200 may receive the sound through the microphone. In response to the received sound including the identification information, the electronic apparatus 200 may generate the response information corresponding to the identification information (S810).

In this case, the sound corresponding to the identification information may be received along with other noises. Accordingly, the sound corresponding to the identification information may be set as a predetermined frequency. The electronic apparatus 200 may extract only the predetermined frequency and determine whether the sound includes the identification information.

The electronic apparatus 200 may transmit the generated response information and perform the pairing with the display apparatus 100 (S820). For example, in response to receiving the response information corresponding to the identification information which is the same as the identification information included in the sound outputted from the display apparatus 100, the display apparatus 100 may transmit a pairing request to the electronic apparatus 200, and the electronic apparatus 200 may transmit a response to the pairing request to the display apparatus 100. Accordingly, the pairing between the display apparatus 100 and the electronic apparatus 200 may be performed.

The above example embodiment was described using an example of the display apparatus 100, but the embodiment is not limited to only an apparatus with a display function.

According to the above-described various example embodiments, apparatuses to be paired may recognize that they are located in the same place through a sound communication method. Accordingly, any other methods for recognizing an existence of an apparatus to be paired (for example, Infrared Rays (IR) communication or image sensing) is not required. Accordingly, the apparatus does not need be equipped with a component, such as, an IR transceiver, which provides more flexibility in the design.

Meanwhile, the above-described various example embodiments may be realized in a recording medium readable by a computer or its equivalents by using software, hardware, or combinations thereof. According to an implementation including hardware, the embodiments may be realized by using, for example, and without limitation, at least one of Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), processors, controllers, micro-controllers, microprocessors, and electric units for executing other functions, or the like. According to an implementation including software, the embodiments with the operations and functions described herein may be realized as software modules. The respective software modules may perform one or more functions and operations described herein.

The method for controlling the display apparatus according to the above-described various example embodiments may be stored in a non-transitory readable medium. The non-transitory readable medium may be installed and used in diverse apparatuses.

The non-transitory readable medium refers to a machine-readable medium that stores data. For example, the above-described various applications and programs may be stored in and provided through the non-transitory readable medium, such as, a Compact Disc (CD), a Digital Versatile Disc (DVD), a hard disc, a Blu-ray disc, a Universal Serial Bus (USB), a memory card, a Read-Only Memory (ROM), or the like.

While various example embodiments have been illustrated and described herein. The foregoing example embodiments and advantages are merely examples and are not to be understood as limiting the present disclosure. The present teaching can be readily applied to other types of devices. Also, the description of the embodiments is intended to be illustrative, and not to limit the scope of the claims, and many alternatives, modifications, and variations will be apparent to a person having ordinary skill in the art.

What is claimed is:

1. A display apparatus comprising:
a display configured to display an image;
a speaker configured to output sound corresponding to identification information identifying the display apparatus;
a communicator comprising communication circuitry configured to wirelessly receive response information corresponding to the identification information from an external apparatus that received the sound; and
a processor configured to perform pairing with the external apparatus that transmitted the response information and to control the display based on a control command received from the paired external apparatus.

2. The display apparatus as claimed in claim 1, wherein the processor is configured to control the speaker to output the sound corresponding to the identification information in response to trigger information being received from the external apparatus through the communicator.

3. The display apparatus as claimed in claim 2, wherein the processor is configured to control the speaker to output the sound corresponding to the identification information in response to an advertising packet including the trigger information being received through the communicator.

4. The display apparatus as claimed in claim 1, wherein the processor is configured to disable the pairing with the external apparatus and to control the speaker to output the sound corresponding to the identification information in response to trigger information being received from another external apparatus through the communicator while the display apparatus is paired with the external apparatus.

5. The display apparatus as claimed in claim 1, wherein the processor is configured to control the speaker to output the sound corresponding to the identification information in response to trigger information being received from another external apparatus through the communicator while the display apparatus is paired with the external apparatus, and to disable the pairing between the display apparatus and the external apparatus and to perform pairing with the another external apparatus in response to the response information corresponding to the identification information being received though the communicator after the sound is output.

6. The display apparatus as claimed in claim 1, wherein the communicator is configured to communicate with the external apparatus using Bluetooth.

7. The display apparatus as claimed in claim 1, wherein the response information comprises an advertising packet including the identification information.

8. The display apparatus as claimed in claim 1, wherein the processor comprises a main processor configured to control the speaker and a sub processor configured to control the communicator, wherein the main processor does not operate in a sleep state of the display apparatus, and wherein the sub processor is configured to wake up the main processor in response to trigger information being received from the external apparatus through the communicator in the sleep state of the display apparatus.

9. The display apparatus as claimed in claim 1, wherein the processor and the communicator are configured to communicate through a Universal Serial Bus (USB).

10. An electronic apparatus connectable to a display apparatus, the electronic apparatus comprising:
a microphone configured to receive sound;
a processor configured to, in response to the sound received through the microphone including identification information, generate response information corresponding to the identification information; and
a communicator comprising communication circuitry configured to perform pairing with the display apparatus by transmitting the generated response information.

11. The electronic apparatus as claimed in claim 10, further comprising:
a plurality of buttons,
wherein the processor is configured to control the communicator to transmit trigger information for causing sound corresponding to the identification information to be output through a peripheral device in response to manipulation of at least one button among the plurality of buttons being detected while there is no paired external apparatus.

12. The electronic apparatus as claimed in claim 11, wherein the processor is configured to incorporate the trigger information in an advertising packet and to control the communicator to transmit the trigger information.

13. The electronic apparatus as claimed in claim 11, wherein the processor is configured to activate the microphone after the trigger information is transmitted.

14. The electronic apparatus as claimed in claim 11, wherein the processor is configured to control the communicator to transmit a control command corresponding to the manipulated button in response to the electronic apparatus being paired with the display apparatus after the trigger information is transmitted.

15. The electronic apparatus as claimed in claim 11, wherein the processor is configured to control the communicator to transmit the control command corresponding to the manipulated button to the display apparatus in response to manipulation of at least one button among the plurality of buttons being detected while the electronic apparatus is paired with the display apparatus.

16. The electronic apparatus as claimed in claim 10, wherein the communicator is configured to communicate with the display apparatus using Bluetooth.

17. The electronic apparatus as claimed in claim 10, wherein the response information comprises an advertising packet including the identification information.

18. A method for controlling an electronic apparatus connectable to a display apparatus, the method comprising:
receiving sound through a microphone;
generating, in response to the received sound including identification information, response information corresponding to the identification information; and
performing pairing with the display apparatus by transmitting the generated response information.

19. The method as claimed in claim 18, further comprising:
transmitting, in response to manipulation of at least one button among a plurality of buttons of the electronic apparatus being detected while there is no external apparatus paired with the electronic apparatus, trigger information for outputting sound corresponding to the identification information through a peripheral device.

20. The method as claimed in claim 19, wherein the transmitting the trigger information comprises incorporating and transmitting the trigger information in an advertising packet.
